(19) United States
(12) Patent Application Publication
(10) Pub. No.: US 2025/0041155 A1
(43) Pub. Date: Feb. 6, 2025

(54) FACIAL BATHING ASSEMBLY

(71) Applicant: The FaceTub LLC, WAYZATA, MN (US)

(72) Inventors: Cullen Christopher Olsen, Excelsior, MN (US); Michael Cosgrove Dejoras, Saint Paul, MN (US); Gabriel Cole Wengler, Long Lake, MN (US)

(21) Appl. No.: 18/789,130

(22) Filed: Jul. 30, 2024

Related U.S. Application Data
(60) Provisional application No. 63/530,041, filed on Jul. 31, 2023.
(60) Provisional application No. 63/534,935, filed on Aug. 28, 2023.

(51) Int. Cl. A61H 35/00; A61H 33/00; A61H 33/02

(52) U.S. Cl. CPC A61H 35/008; A61H 33/02; A61H 33/6021

(57) ABSTRACT

A facial basin assembly includes a basin with a convex top side and a concave bottom side. The assembly features a mouthpiece to facilitate user breathing while their face is submerged in liquid. The mouthpiece is connected to a coupling device via one or more air flow conduits. This coupling device is designed to be removably inserted through a ledge of the basin and is adapted to direct the user's exhalation toward the bottom of the basin. The basin comprises a base portion and a curved portion, the latter allowing exhaled breath to escape into the environment.

### CROSS-REFERENCE TO RELATED APPLICATIONS

This application claims priority to and the benefit of U.S. Provisional Application No. 63/530,041, filed Jul. 31, 2023, titled “FACIAL BATHING DEVICE”, and U.S. Provisional Application No. 63/534,935, filed Aug. 28, 2023, titled “FACIAL BATHING DEVICE”, the disclosure of each is hereby incorporated by reference herein in their entirety.

### BACKGROUND

Facial bathing has long been recognized as a beneficial practice for improving skin health and mental well-being. Traditional methods, such as splashing water on the face, applying facial masks, and short interval submersions, have limitations in providing immersive and comprehensive results.

Current technology related to facial bathing involves complex devices that facilitate the submersion of the face, which results in difficult maintenance and production requirements. For example, U.S. Pat. No. 10,667,991 features a complex setup with various electronic and mechanical components, making it difficult to clean and manufacture. Additionally, U.S. Pat. No. 10,667,991 also describes a system using a breathing mechanism that exhausts upwards towards the face. This design allows liquid to easily enter the exhaust port when in use, such as when the user enters or exits the facial bath. This makes it difficult to breathe and maintain sanitary conditions for use.

Another technology, illustrated in US Pub. No. 2008/0234610, includes an exhaust port directly connected to a mouthpiece at the bottom center of the basin. While this directs exhaust at the bottom of the basin, the exhaust port's position at the center of the basin's bottom forces the user to maintain a deep face submersion. Thus, there is a need for a facial bathing system that allows users flexibility in head movement within the face bath, is simple to use and manufacture, and prevents liquid from entering the exhaust port.

It is with respect to these and other considerations that the technologies described below have been developed. Also, although relatively specific problems have been discussed, it should be understood that the embodiments should not be limited to solving the specific problems identified in the introduction.

### BRIEF SUMMARY

It is to be understood that both the foregoing introduction and the following detailed description are exemplary and explanatory and are intended to provide further explanation of the innovative technologies as claimed.

The technology includes a facial basin assembly designed to hold a liquid, allowing users to place their face in the basin and breathe through a mouthpiece. The mouthpiece is, in examples, coupled to one or more airflow conduits, which may be a tubular body. The tubular body may allow for some movement of the user's head within the basin while allowing the user to breathe through the mouthpiece. The airflow conduit is, in examples, coupled to a coupling device. This coupling device may be removably inserted into or proximate to a top ledge of the facial basin assembly. The coupling device features an airflow pathway that allows the user to inhale and exhale, directing their breath downward through the top ledge of the basin towards the bottom of the basin, in examples. The coupling device can be removably inserted into a receiving element located on or near the edge of the basin through the use of a press fit, slotted grooves or other coupling features.

One benefit of this technology is that users can utilize the facial bath in various positions. In some examples, the airflow conduit is flexible and elastic, enabling a user to position his/her face at different locations within the basin, whether closer to the bottom, further up, towards the front, or back of the basin. Additionally, for some examples, the relatively simple construction of the system allows for easy maintenance and manufacturing. Moreover, in some examples, the coupling device has a top that is not readily exposed to the environment, thus inhibiting the ability of a liquid to enter the airflow pathway during use.

In a first example, a facial basin assembly comprises a basin with a concave top side capable of retaining a liquid. The concave top side, in the example, has an interior surface and is opposite a bottom side. A receiving element, in the example, is disposed proximate to a ledge that is circumferentially disposed about the interior surface. A coupling device, in the example, is removably inserted into the receiving element. The coupling device, in the example, comprises a body that defines, in part, an airflow pathway and at least one inlet/outlet. The airflow pathway, in the example, is adapted to exhaust air proximate to the bottom side of the basin. Additionally, a first airflow conduit with a tubular body is disposed near the concave top surface, in examples. The first airflow conduit, in examples, has a first proximate end coupled to the first inlet/outlet and a first distal end coupled to a mouthpiece at a coupling end. The mouthpiece comprises a body defining an airflow passage from an engagement end to at least the first coupling end, in examples.

In one example, the coupling device body is of a unitary construction. In another/additional example, the coupling element includes at least one slotted groove adapted to receive a corresponding protrusion from the receiving element. Additionally, the coupling device may feature a second inlet/outlet in fluidic connection with the intake/exhaust orifice, positioned opposite the first inlet/outlet. In a further example, a second airflow conduit with a tubular body is disposed within the top surface and is coupled to the second inlet/outlet at a second proximate end, with the distal end of the second airflow conduit coupled to the mouthpiece at a second coupling end, opposite the first coupling end. The basin may also comprise a sidewall with a base portion and a curved portion, allowing air transfer from the bottom side of the basin to the environment. The coupling device may be attached to the bottom side of the basin at a receiving element. In certain configurations, including but not limited to the previous examples, the receiving element includes at least one protrusion that corresponds to at least one slot in the coupling device. The assembly may further include a plurality of support elements disposed on a bottom convex surface.

### BRIEF DESCRIPTION OF THE DRAWINGS

Illustrative examples of the present invention are described in detail below with reference to the attached drawings, wherein:

FIG. 1A illustrates a front perspective view of an example facial bathing assembly with environment.

FIG. 1B illustrates a front perspective view of an example facial bathing assembly.

FIG. 1C illustrates a bottom perspective view of an example facial bathing assembly.

FIG. 1D illustrates a front view of an example facial bathing assembly.

FIG. 1E illustrates a back view of an example facial bathing assembly.

FIG. 1F illustrates a right-side view of an example facial bathing assembly.

FIG. 1G illustrates a left-side view of an example facial bathing assembly.

FIG. 1H illustrates a top view of an example facial bathing assembly.

FIG. 1I illustrates a bottom view of an example facial bathing assembly.

FIG. 2 illustrates an exploded view of an example facial bathing assembly.

FIG. 3A illustrates a perspective view of an example mouthpiece.

FIG. 3B illustrates a back view of an example mouthpiece.

FIG. 3C illustrates a front view of an example mouthpiece.

FIG. 3D illustrates a left-side view of an example mouthpiece.

FIG. 3E illustrates a right-side view of an example mouthpiece.

FIG. 3F illustrates a top view of an example mouthpiece.

FIG. 3G illustrates a bottom view of an example mouthpiece.

FIG. 4A illustrates a perspective view of an example coupling device.

FIG. 4B illustrates a back view of an example coupling device.

FIG. 4C illustrates a front view of an example coupling device.

FIG. 4D illustrates a right-side view of an example coupling device.

FIG. 4E illustrates a left-side view of an example coupling device.

FIG. 4F illustrates a top view of an example coupling device.

FIG. 4G illustrates a bottom view of an example coupling device.

FIG. 4H illustrates a perspective back view of an example coupling device

FIG. 5 illustrates a detailed top view of an example receiving element.

FIG. 6 illustrates a detailed bottom view of an example receiving element.

FIG. 7 illustrates an example airflow conduit.

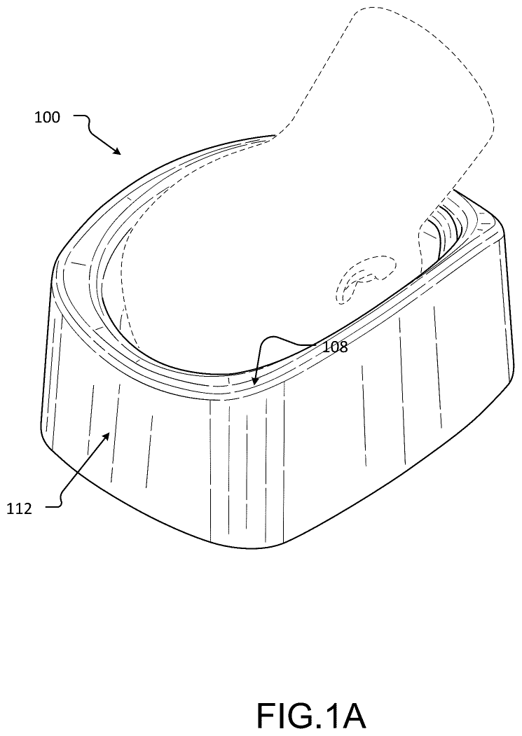

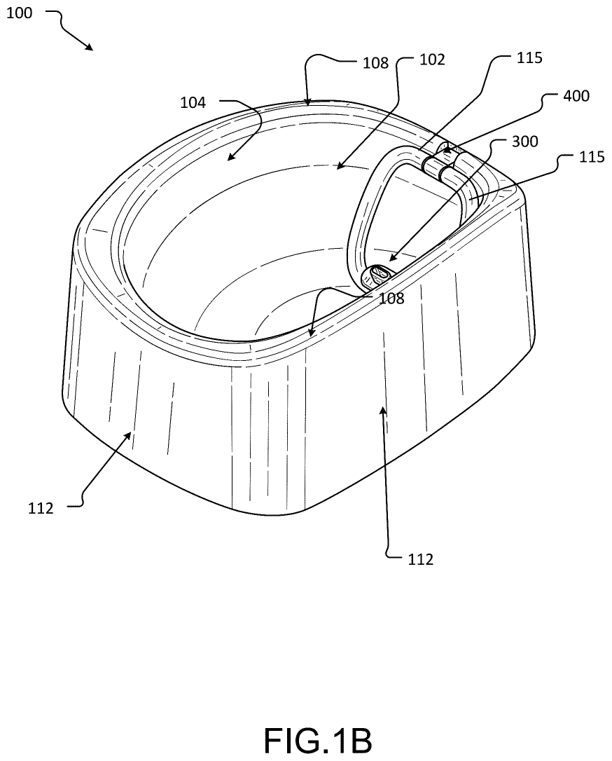

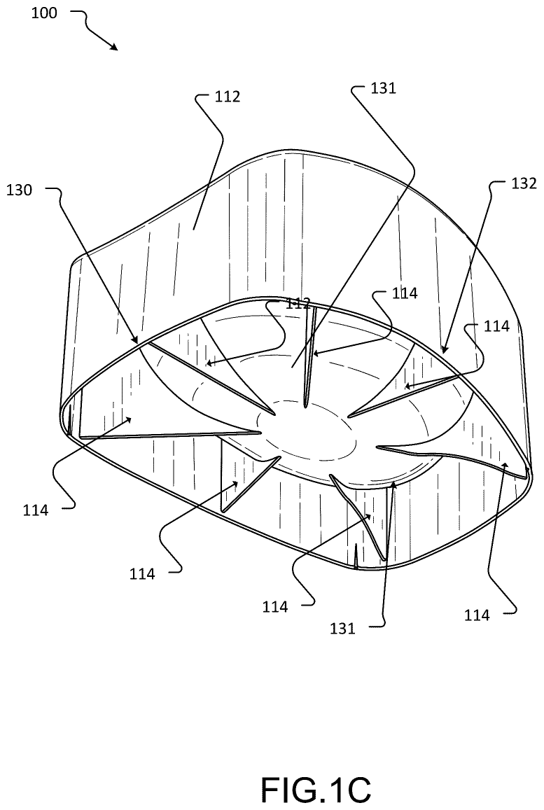

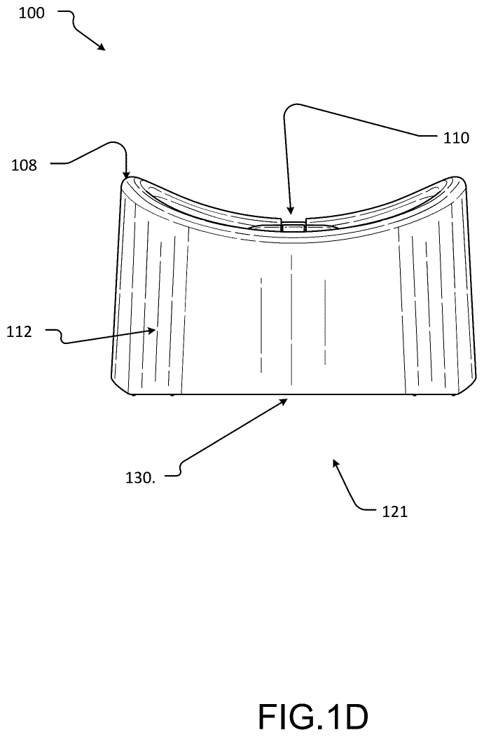

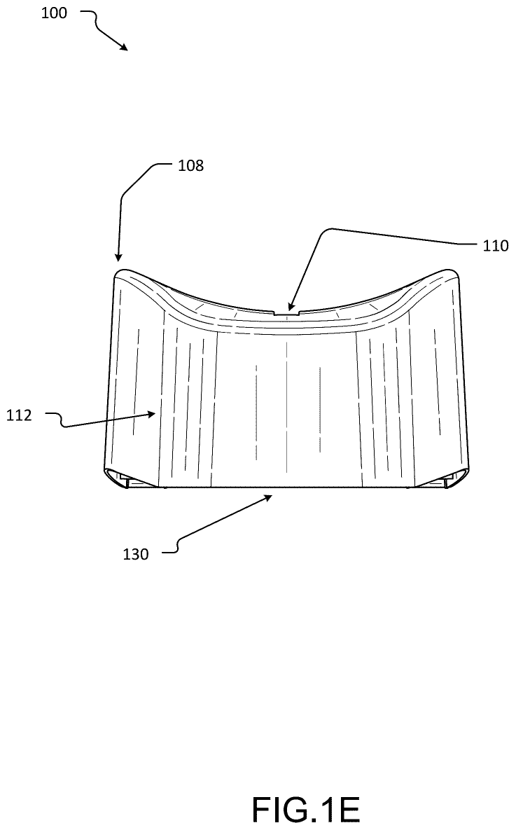

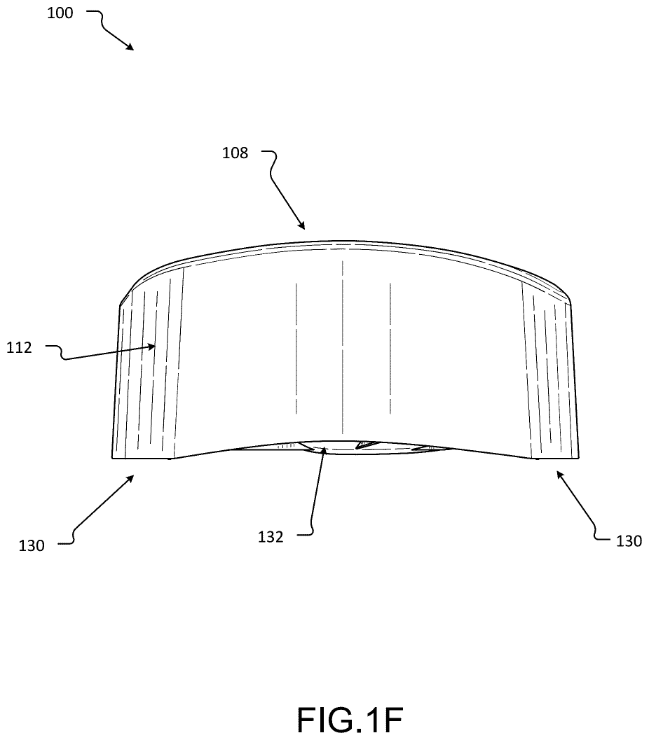

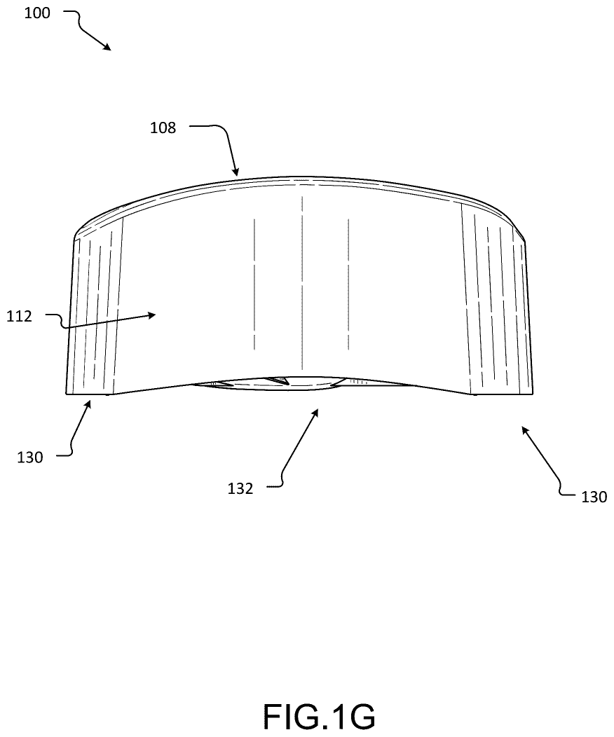

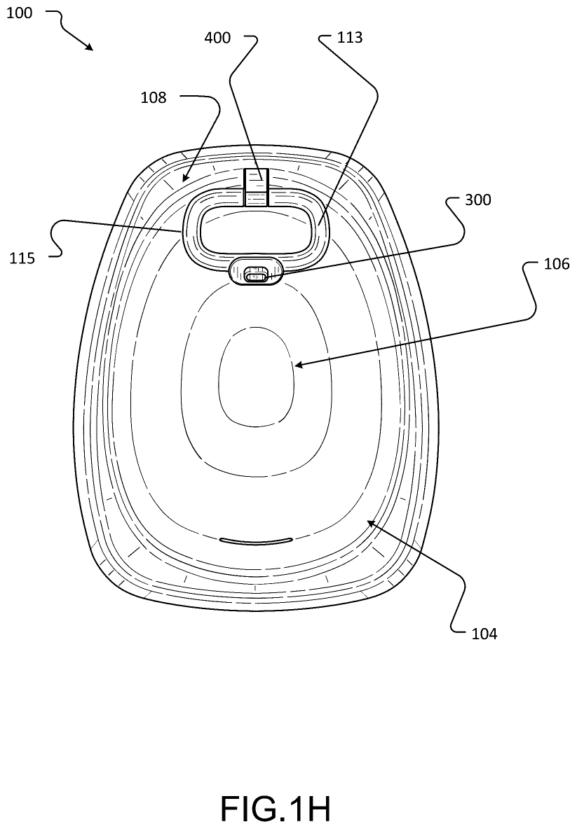

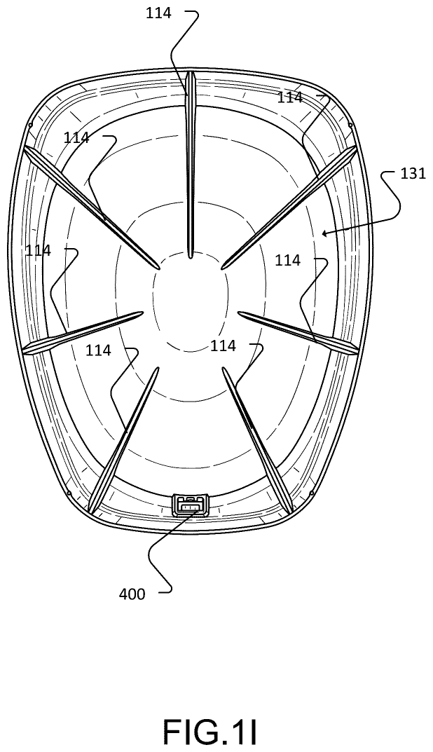

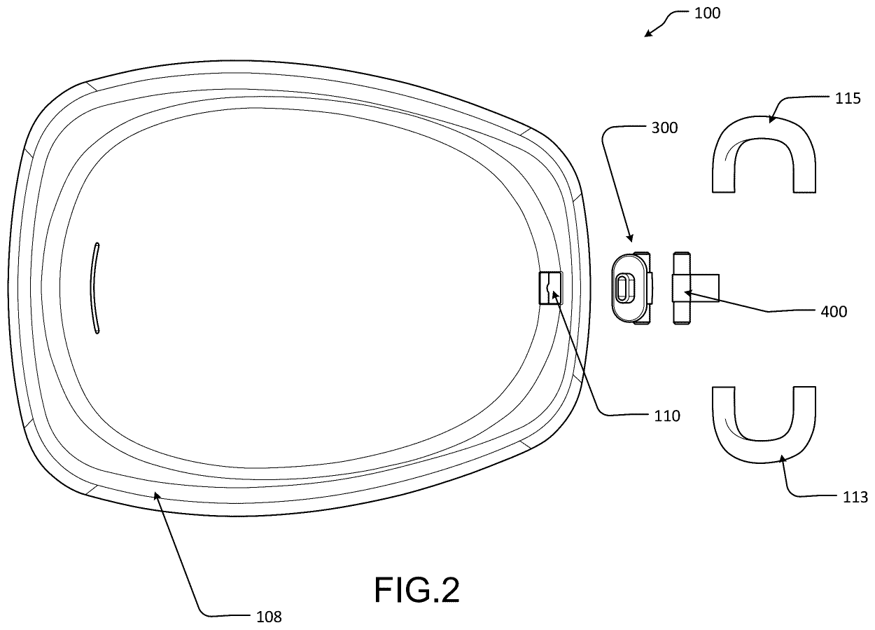

### DETAILED DESCRIPTION

In general, the terms and phrases used herein have their art-recognized meaning, which can be found by reference to standard texts, journal references and contexts known to those skilled in the art. The following definitions are provided to clarify their specific use in the context of this description.

“Proximal” and “distal” refer to the relative positions of two or more objects, planes, or surfaces. For example, an object that is close in space to a reference point relative to the position of another object is considered proximal to the reference point, whereas an object that is further away in space from a reference point relative to the position of another object is considered distal to the reference point. In certain instances, which will be apparent through the context of use, the term proximal refers to a position that is closer to the user's body when the facial basin assembly is in normal use, whereas distal means further away from a user's body when the facial basin assembly is in normal use.

In general, references to the “top side,” “top,” “bottom side,” or “bottom” pertain to the orientation of the facial basin assembly during normal use. Specifically, the “top side” is the side oriented in the direction where a user places their face, while the “bottom side” is the side where the basin rests on a surface.

With references to the figures, an example facial basin assembly 100 includes a basin 102. The basin 102 has a concave top-side surface 104 capable of retaining a fluid, such as water, ice water, or other facial liquid. Circumferentially disposed along the edge of the basin 102 is a ledge 108. In examples, the basin may include a drain plug (not shown). In additional/alternative examples, the basin 102 may be made of a material suitable for facials, such as plastic, stainless steel, glass, ceramic, silicone, acrylic, composite materials, and medical-grade polymers.

As shown in the figures, a sidewall 112 extends downwardly from the edge of the ledge 108. In examples, the sidewall 112 provides structural support for the basin 102. As illustrated, a plurality of support elements 114 are disposed about a convex bottom side surface 131, connecting the sidewall 112 to the convex bottom side surface 131. As illustrated, the sidewall has a base area 130 and a curved area 132. When sitting on a flat surface, the base area 130 may provide support for the weight of the facial basin assembly 100, along with any liquid in the basin 102, while the curved area 132 allows for air from the environment to flow under the sidewall to the coupling device 400. That is, the illustrated curved area 132 is concave with respect to a flat surface upon which the facial basin assembly may sit during use.

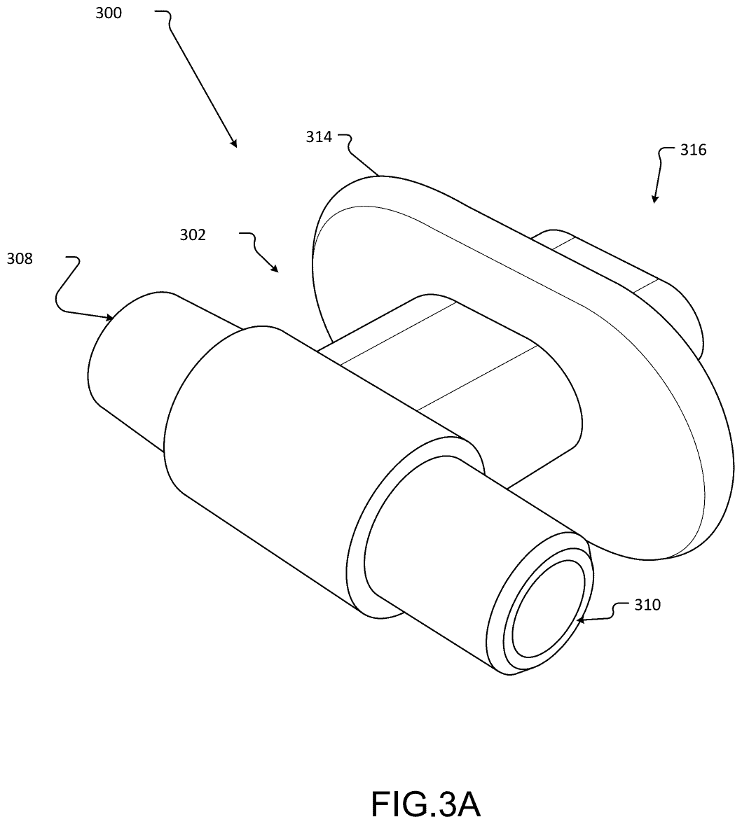

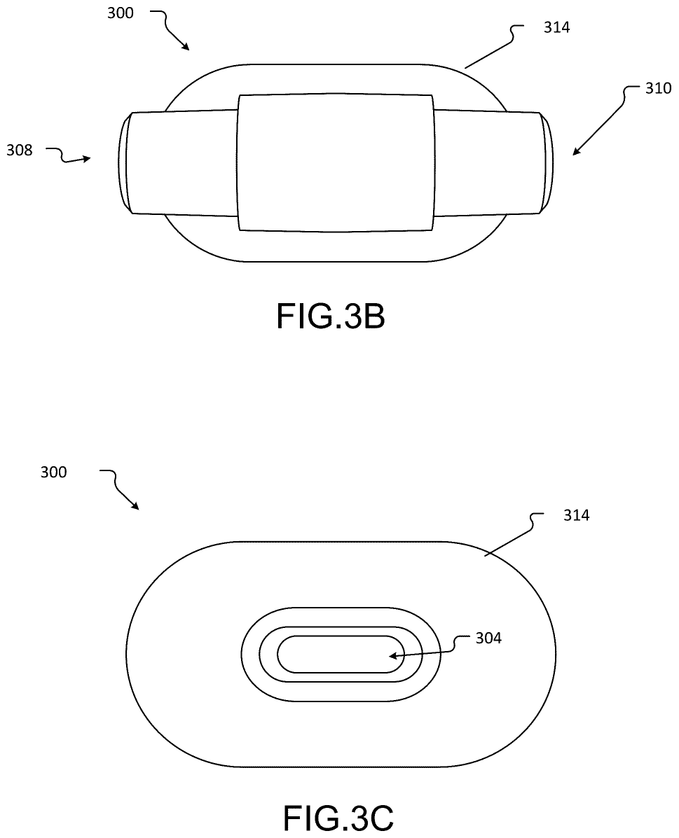

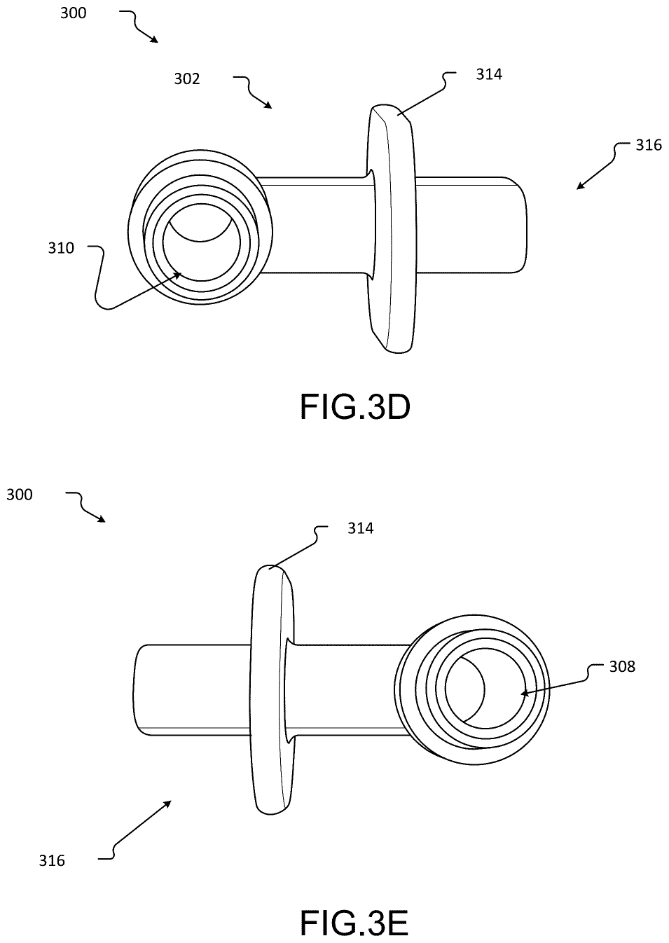

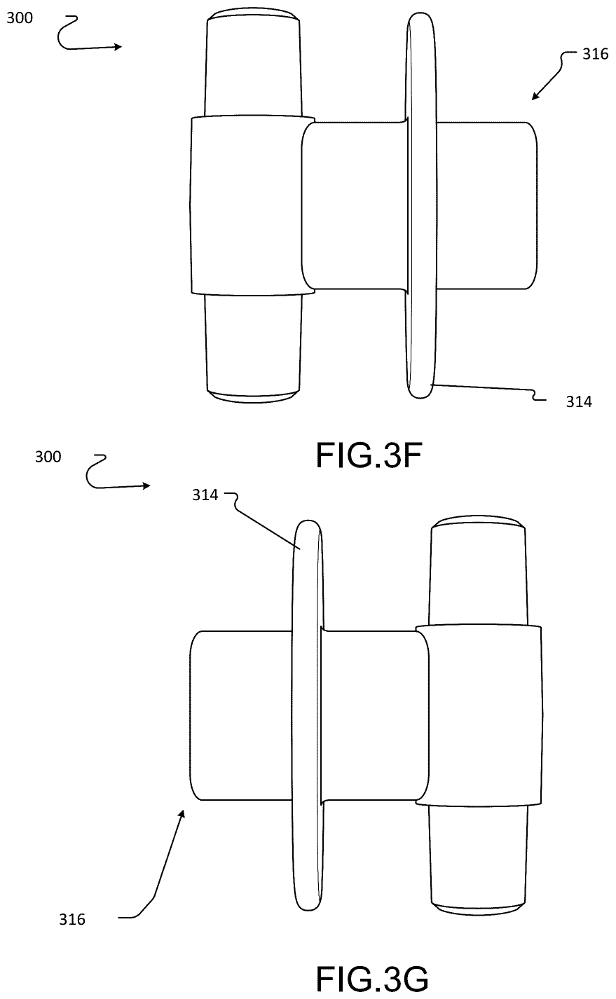

A mouthpiece 300 is illustrated as proximate to the interior surface 106. Indeed, as illustrated, the mouthpiece 300 is disposed about a topside of the concave top-side surface 104. The mouthpiece 300 is configured to be inserted into a user's mouth to facilitate breathing by a user. Details of the example mouthpiece are illustrated in FIGS. 3A through 3G. The example mouthpiece 300 shown includes an engagement end 316. The engagement end 316 is configured for a user to place their mouth over the engagement end 316 and breathe through the mouthpiece 300. A shield 314 is illustrated as protruding orthogonally from the body 302 of the mouthpiece 300. The shield 314 is also illustrated as proximate to the engagement end 316. The example shield 314 prevents, in some instances, the user from inadvertently inserting the mouthpiece 300 deep into the user's mouth. Airflow through the body 302 of the mouthpiece 300 is facilitated by an airflow passage 304. The airflow passage 304 is illustrated as beginning at an engagement end 316, passing through the body 302, and exiting at a first coupling end 308 that is opposite a second coupling end 310. In examples, only a single coupling end may be used. In additional examples, more than two coupling ends may be present.

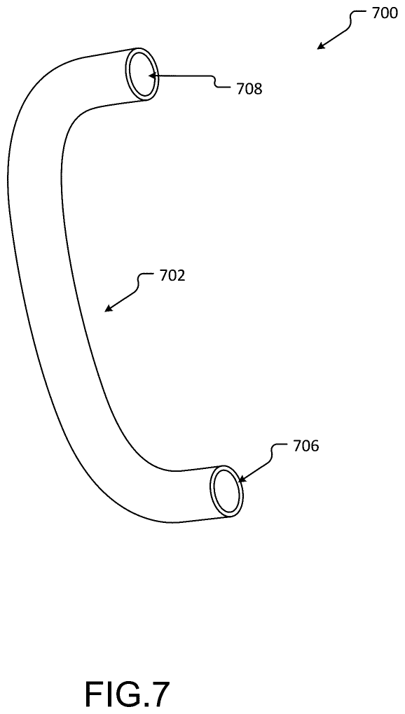

As illustrated in the figures, the first coupling end 308 is coupled to a first airflow conduit 113, and the second coupling end 310 is coupled to a second air flow conduit 115. The airflow conduits 113 and 115 are adapted to transport air (or other breathable gas, such as an oxygen-nitrogen mix) when submerged in a liquid. An example air flow conduit, which may be used as a first air flow conduit 113 and a second air flow conduit 115, is illustrated in FIG. 7 as air flow conduit 700.

The illustrated airflow conduit 700 includes a tubular body 702 having a lumen, wherein the lumen passes through a distal end 706 to a proximate end 708. It will be appreciated to one skilled in the art that more or less airflow conduits suitable for conveying air from a user's mouth through the basin toward an exhaust may be used. For example, the airflow conduit may be a tube designed to be collapsible and expandable, featuring an accordion-like structure. This flexible, pleated design may allow, in some examples, the tube to be compressed to a compact form for storage and extended to its full length when in use. The accordion structure provides both flexibility and stability, enabling it to adapt to various lengths and positions as needed. In examples, the airflow conduit comprises one or more of the following materials: silicone, rubber, PVC (polyvinyl chloride), polyurethane, TPE (thermoplastic elastomer), medical-grade plastic, stainless steel, flexible plastic, EPDM (ethylene propylene diene monomer), and latex.

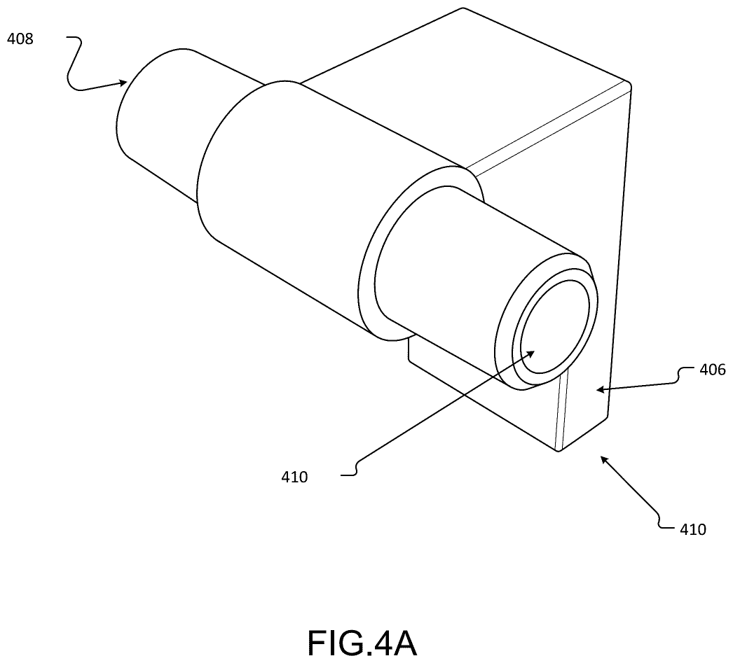

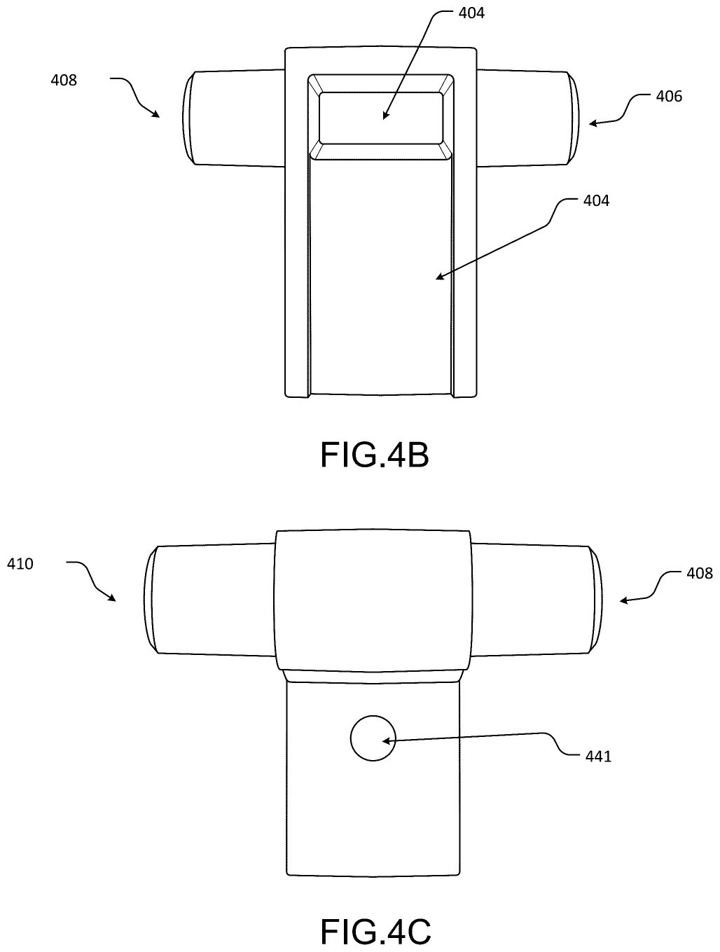

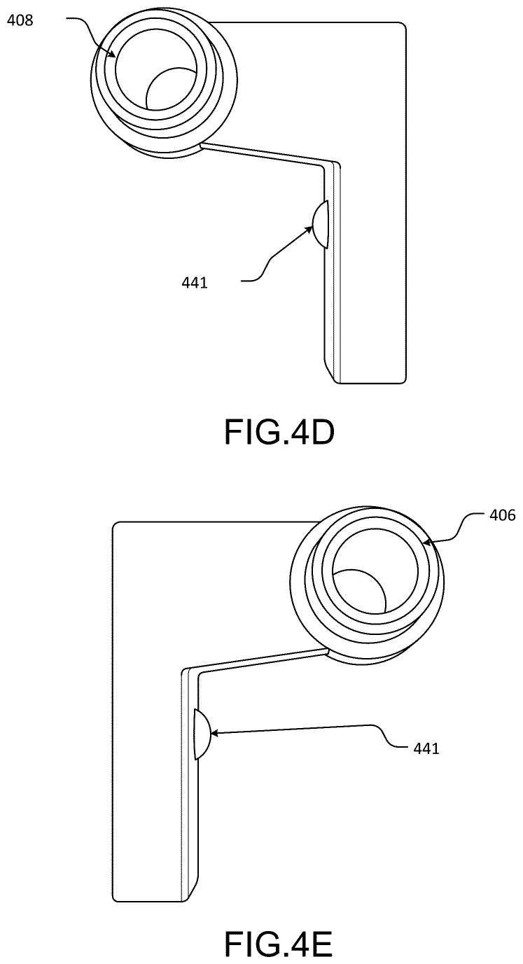

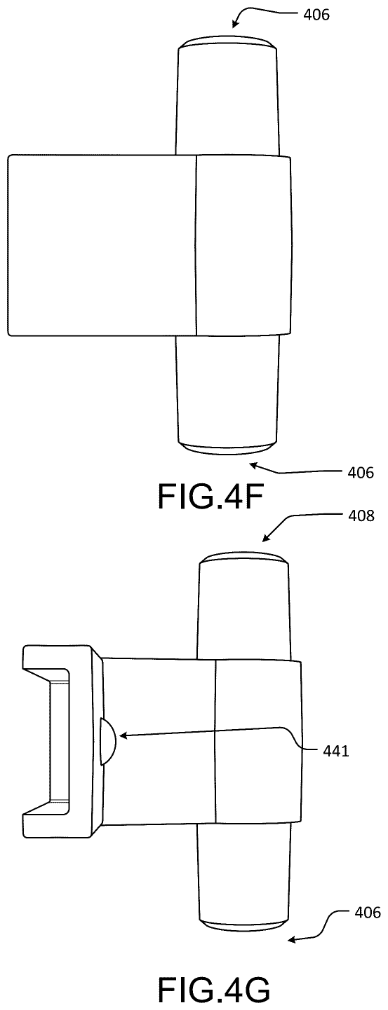

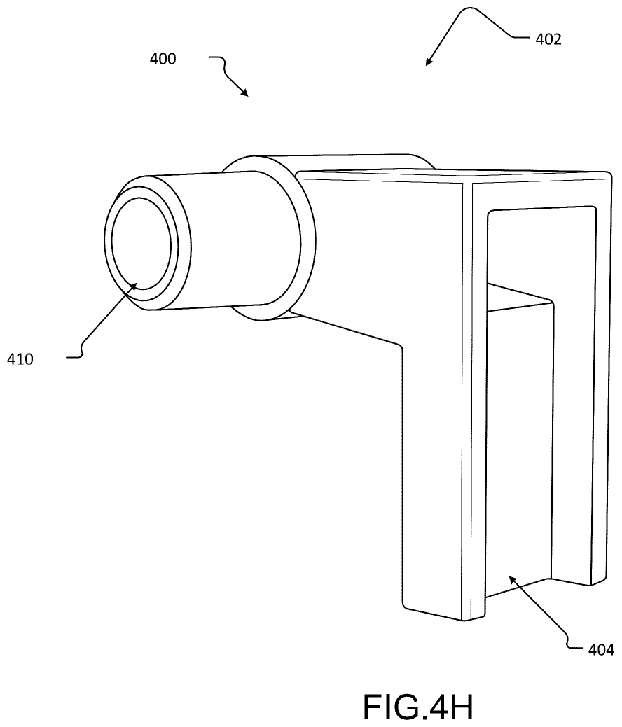

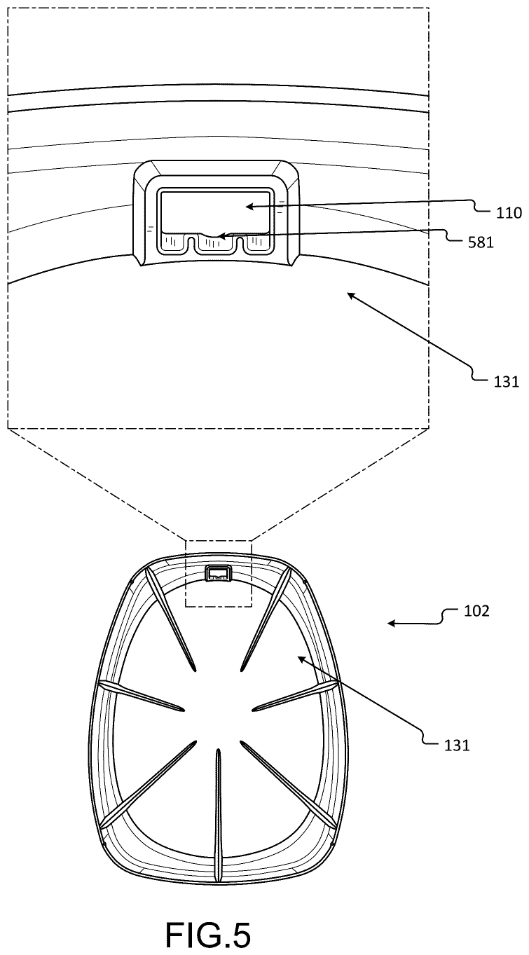

As illustrated, the first airflow conduit 113 is coupled to a coupling device 400 at a first inlet/outlet, while the second airflow conduit 115 is coupled to the coupling device 400 at a second inlet/outlet. Details of the coupling device 400 are shown in FIGS. 4A-H. The coupling device 400 features a coupling body 402, which defines in part an airflow pathway 404. This pathway directs, in examples, air from the bottom side 410 of the body 402 to the first inlet/outlet 406 and the second inlet/outlet 408 when inhaled.

Additionally, the coupling body 402 is designed to direct the airflow downward toward the bottom side 410 and the bottom side 131 of the basin. When the coupling device 400 is inserted into a receiving element 110, the combination of the basin's bottom side surface and the airflow pathway 404 directs air from the bottom side 131 of the basin to the inlet/outlets during inhalation and from the inlet/outlets during exhalation.

In examples, the coupling device 400 is removably inserted into the receiving element 110. As illustrated, the receiving element 110 is disposed about the ledge 108 of the basin 102. Further illustrated, the receiving element 110 is located at a proximal end of the basin 102. In alternative/additional examples, one or more receiving elements may be located at a distal end or along any portion of the ledge, such as the side of a basin. It will be appreciated that more than one or more receiving elements capable of receiving a coupling device may be used without deviating from the scope of the innovative technologies described herein. For example, four coupling devices may be removably inserted into a ledge of a basin. Such a configuration may, in some examples, allow for easier breathing by a user. In such an example, the mouthpiece will be adapted to be in fluidic communication with the airflow pathway of each coupling device. For example, the mouthpiece may comprise a body that includes four coupling ends, each coupled to an airflow conduit, and those airflow conduits are coupled to a coupling device having four inlet/outlets.

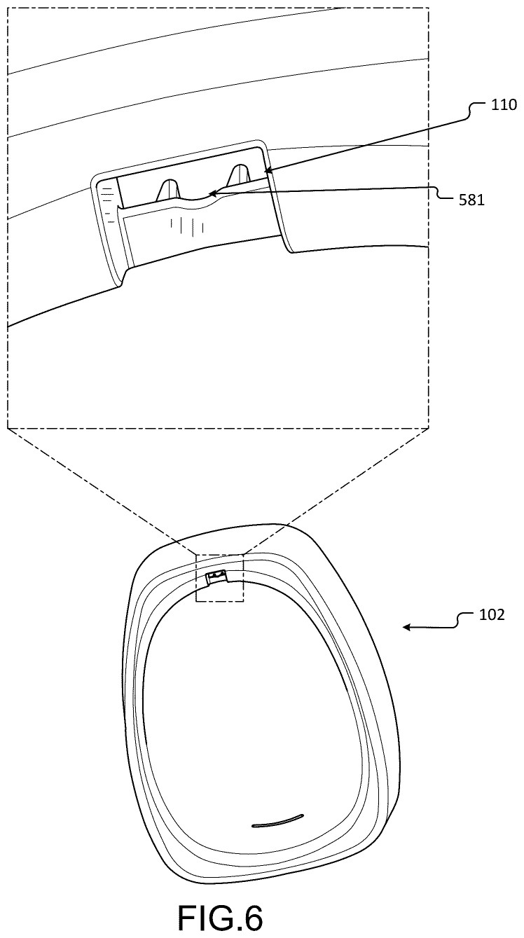

FIG. 5 and FIG. 6 provide examples of a receiving element 110 capable of receiving the illustrated coupling device 400. As illustrated, a recess 581 is adapted to receive a protrusion, such as protrusion 441 illustrated in FIGS. 4C, 4D, 4E, and 4G. The protrusion 441 press fits into the recess 581 to form a removable coupling. In this way protrusion 441 serves as a coupling element. A coupling element is an element that allows a coupling device to be removably inserted into the basin 102.

Various other means of removably coupling a coupling device 400 to the wall 112 and/or the convex bottom side surface 131 are contemplated. For example, a coupling device may be securely and removably seated with the wall 112 and/or the convex bottom side surface 131 through several robust mechanisms. One example includes a slotted groove on the wall 112 and/or the convex bottom side surface 131 that corresponds to one or more protrusions on the coupling device 400. Additionally, the coupling device 400 may feature a snap-fit mechanism, where flexible tabs on the device engage with recesses on the wall 112 and/or the convex bottom side surface 131, providing a firm and easily releasable connection. Another method involves the use of a threaded connection, where the coupling device 400 includes external threads that mate with internal threads on the wall 112 and/or the convex bottom side surface 131, allowing for a tight and adjustable fit. Alternatively, a bayonet coupling can be employed, where the coupling device 400 has L-shaped slots that align with pins on the wall 112 and/or the convex bottom side surface 131. A magnetic coupling is another option, with magnets embedded in one or both the coupling device 400 and the wall 112 and/or the convex bottom side surface 131 to facilitate a quick and firm attachment. Furthermore, a latch mechanism can be utilized, where a latch on the coupling device 400 engages with a corresponding catch on the convex bottom side surface 131, or vice versa, providing a secure and easily releasable connection.

1. A facial basin assembly comprising:
a basin with a concave top side capable of retaining a liquid, wherein the concave top side has an interior surface and is opposite a bottom side;
a receiving element disposed proximate to a ledge that is circumferentially disposed about the interior surface;
a coupling device removably inserted into the receiving element;
wherein the coupling device comprises:
a body defining, in part, an airflow pathway and at least one inlet/outlet, wherein the airflow pathway is adapted to exhaust air proximate to the bottom side of the basin; and
a first airflow conduit having a tubular body disposed near the concave top surface, the first airflow conduit having a first proximate end coupled to the first inlet/outlet and a first distal end coupled to a mouthpiece at a coupling end, wherein the mouthpiece comprises a body defining an air flow passage from an engagement end to at least the first coupling end.

2. The facial basin assembly basin of claim 1, wherein the body of the coupling device is of a unitary construction.

3. The facial basin assembly basin of claim 1, wherein the coupling element comprises at least one slotted groove adapted to receive a corresponding protrusion of the receiving element.

4. The facial basin assembly of claim 1, wherein the coupling device further comprises a second inlet/outlet in fluidic connection with the intake/exhaust orifice, and the second inlet/outlet opposite the first inlet/outlet.

5. The facial basin assembly of claim 2, wherein a second airflow conduit having a second tubular body disposed within the top surface is coupled to the second inlet/outlet at a second proximate end, and a distal end of the second airflow conduit is coupled to the mouthpiece at a second coupling end opposite the first coupling end.

6. The facial basin assembly of claim 1, wherein the basin further comprises a sidewall having a base portion and a curved portion such that air can transfer from a bottom side of the basin to the environment.

7. The facial basin assembly of claim 6, wherein the coupling device couples to the bottom side of the basin at a receiving element.

8. The facial basin assembly of claim 7, wherein the receiving element comprises at least one protrusion corresponding to at least one slot of a coupling device.

9. The facial basin assembly of claim 1, further comprising a plurality of support elements disposed on a bottom convex surface.
